(19) United States
(12) Patent Application Publication
(10) Pub. No.: US 2003/0168818 A1
(43) Pub. Date: Sep. 11, 2003

(54) Cylinder head gasket comprising stopper with variable thickness and method for making and fixing same

(76) Inventor: Frederic Pepin, Nantiat (FR)

Correspondence Address: YOUNG & THOMPSON, 745 SOUTH 23RD STREET 2ND FLOOR, ARLINGTON, VA, 22202

(21) Appl. No.: 10/381,977

(22) PCT Filed: Oct. 3, 2001
(86) PCT No.: PCT/FR01/03048

(30) Foreign Application Priority Data
Oct. 4, 2000 (FR) 00/12669

(51) Int. Cl. F02F 11/00

(52) U.S. Cl. 277/593

(57) ABSTRACT

The invention concerns a cylinder head gasket designed to be arranged between a cylinder block and a cylinder head with at least an orifice (12) corresponding to a combustion chamber and orifices (14) allowing through means for fixing said cylinder head on said cylinder block, comprising a stack of at least a metal plate (16, 20) including a rib (18, 22) arranged around the orifice corresponding to the combustion chamber, and at least a metal plate (24) serving as wedge, and a wedge, called stopper (26), designed to limit the compression of the rib (18). The invention is characterised in that the stopper (26) and the metal plate (24) serving as wedge are arranged edge-to-edge.

The present invention relates to a gasket, particularly a cylinder head gasket, provided with a stopper with variable thickness, disposed edge to edge, as well as a process for production and securement of said stopper. The present invention is more particularly adapted to multi-sheet cylinder head gaskets comprising at least two sheets of which one is ribbed.

In a known manner, the cylinder head gasket is interposed between the engine block and the cylinder head and must ensure sealing, on the one hand, between these two elements and, on the other hand, between the volumes passing through this interface, such as about combustion chambers, holes for the passage of fluids, water or oil, and holes for the passage of securement screws.

To improve the efficiency of new motors, the internal pressures of the combustion chamber are higher and higher, which gives rise to increasingly great stresses in the cylinder head gaskets.

Thus, to ensure best sealing, the cylinder head gaskets comprise peripheral ribs, particularly about the combustion chambers. According to a widespread embodiment, the cylinder head gasket thus comprises at least two superposed sheets of which one is ribbed.

Supplementally, at the edge of the passage openings, in particular the openings for the combustion chambers, a so-called stopper wedge is provided so as to ensure the function of limiting the compression of the ribs. This wedge permits a high pressure in the combustion chambers, the cylinder head gasket being strongly compressed between the engine block and the cylinder head by securement screws, without however the ribs being flattened.

According to a first embodiment, the stopper is fixed by welding on the surface of the flat sheet facing the ribbed sheet. Numerous welding techniques are described in the prior art, particularly in French patent application FR 00.00527 in the name of the applicant.

Another solution consists in providing an increased thickness on the surface of the flat sheet facing the ribbed sheet, by sintering for example.

In both cases, the stopper is disposed against one of the surfaces of the sheet to which it is connected.

Even if the anti-crushing function is achieved, the cylinder head gaskets of the prior art do not give complete satisfaction because the processes for production, particularly those of the stopper, are relatively complicated and long to practice. Moreover, when using these processes, it is difficult to cause the profile of the stopper to vary.

Thus, the present invention seeks to overcome the drawbacks of the prior art by providing a new cylinder head gasket as well as a new process for production of said gasket, particularly as to the step of producing and securing the stopper, relatively simple and rapid to practice, which permits if desired a variation of the profile of the stopper about its circumference, so that the cylinder head gasket thus obtained will have tighter sealing.

To this end, the invention has for its object a cylinder head gasket with at least one opening corresponding to a combustion chamber, comprising on the one hand a stack of at least one metal sheet comprising a rib provided about the opening corresponding to the combustion chamber, and at least one metal sheet serving as a wedge, and on the other hand, a wedge, called a stopper, provided to limit the compression of the rib, said stopper and said sheet serving as a wedge being disposed edge to edge and comprising connection means, characterized in that said connection means are obtained by plastic deformation, more particularly by radial expansion of said stopper, this latter having, before deformation, an external diameter equal to or slightly less than the internal diameter of the sheet serving as a wedge and being disposed edge to edge relative to said sheet.

According to another characteristic of the invention, the connection means comprise two flanges at the stopper, on each side of the sheet, thus gripping said sheet.

Preferably, the stopper has a thickness which varies about its circumference, with reduced thickness in the regions situated angularly in line with the passage openings and a greater thickness in the intermediate regions.

In this case, the stopper comprises indexing means so as to position it angularly relative to the rest of the gasket, and particularly relative to the passage openings.

According to a preferred embodiment, the stopper comprises a body and on at least one of the surfaces of the body facing the ribbed sheet, a projecting rib.

Preferably, the projecting rib has a symmetrical profile about a vertical axis of the cross-section of the stopper.

The invention also provides a process for securement of the stopper used in a cylinder head gasket defined above, characterized in that the connection between the stopper and the sheet serving as a wedge is obtained by plastic deformation, more precisely by radial expansion of said stopper, this latter having, before deformation, an external diameter equal to or slightly less than the internal diameter of the sheet and being disposed edge to edge relative to this latter.

According to another characteristic, the securement of the stopper on the sheet serving as a wedge is achieved not only by radial expansion but also thanks to the formation of two flanges at the stopper, on each side of the sheet, thereby gripping said sheet.

Preferably, the radial expansion necessary for the securement of the stopper is produced at the time of production of the desired profile of the stopper, obtained by plastic deformation, particularly by stamping.

Other characteristics and advantages will become apparent from the description which follows of the device of the invention, which description is given by way only of example, with respect to the accompanying drawings, in which:

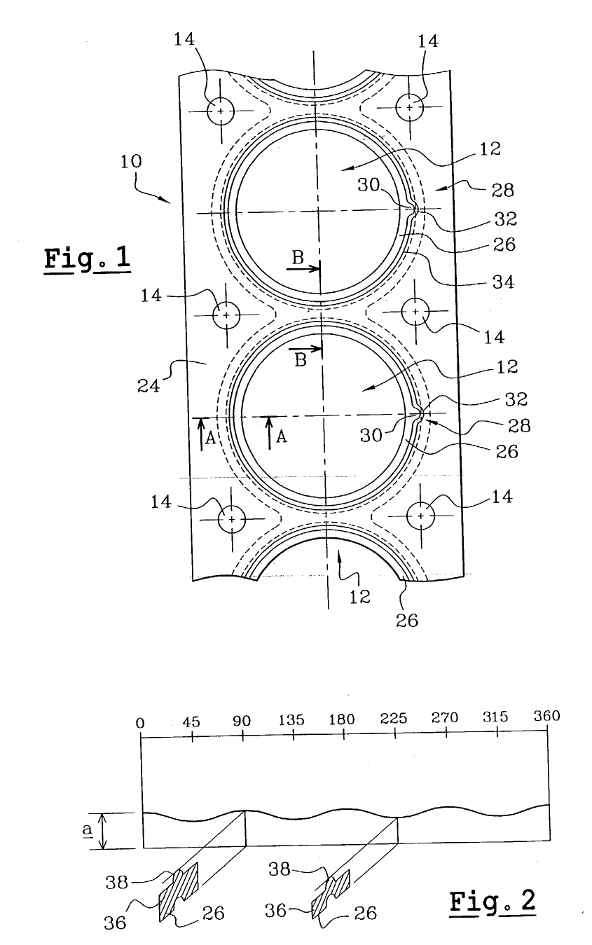

FIG. 1 is a cross-sectional view in the plane of the stopper of a cylinder head gasket according to the invention,

FIG. 2 is a schematic illustration of the variations of thickness of the stopper,

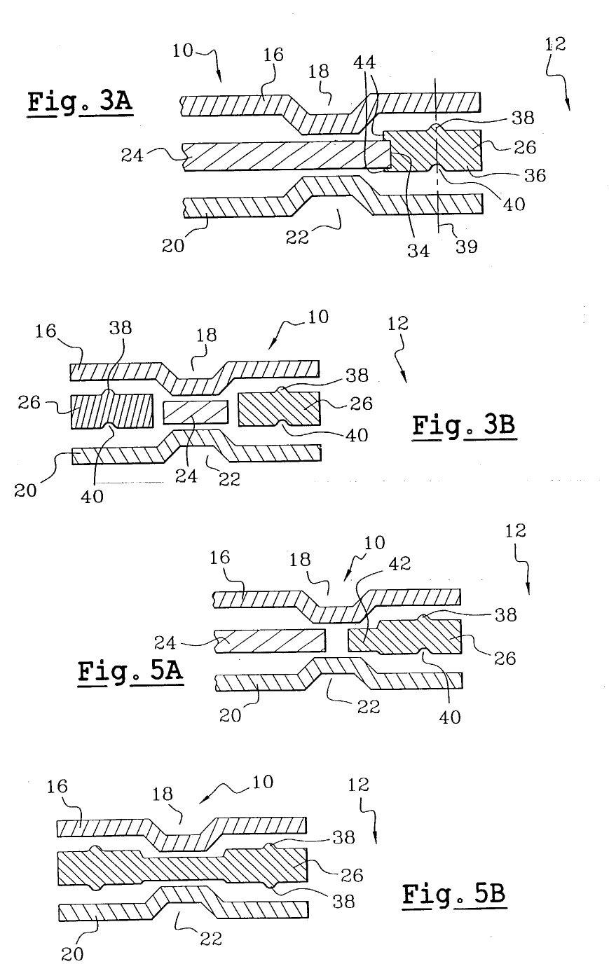

FIG. 3A is a transverse cross-section on the line A-A of the cylinder head gasket of FIG. 1,

FIG. 3B is a transverse cross-section on the line B-B of the cylinder head gasket of FIG. 1,

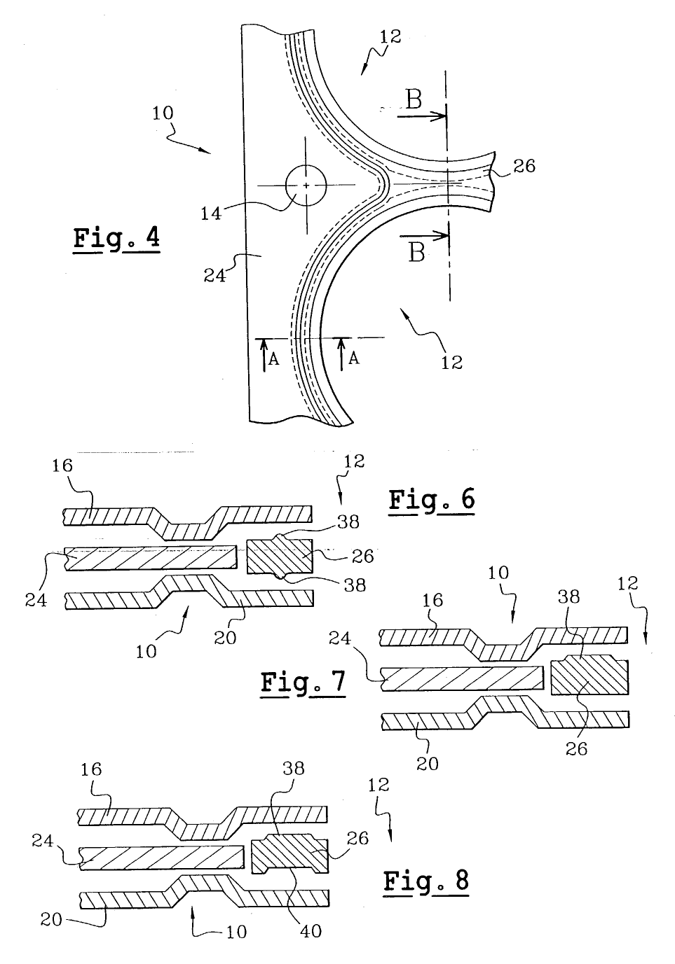

FIG. 4 is a cross-sectional view in the plane of the stopper of a cylinder head gasket according to a modification of the invention,

FIG. 5A is a transverse cross-sectional view on the line A-A of the cylinder head gasket of FIG. 4,

FIG. 5B is a view in transverse cross-section on the line B-B of the cylinder head gasket of FIG. 4,

FIGS. 6 to 8 are cross-sectional views showing examples of profiles of stopper, and

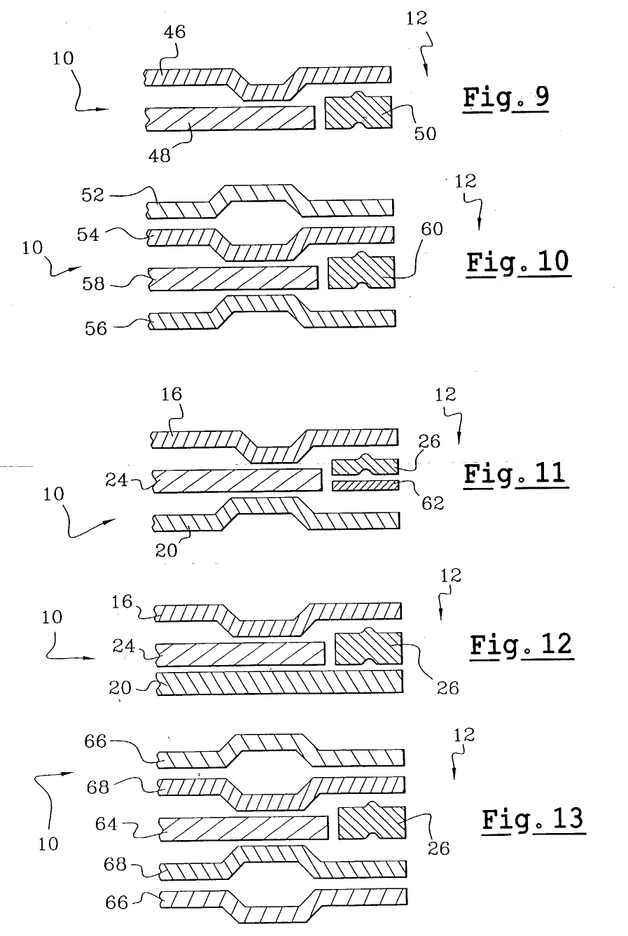

FIGS. 9 to 13 are cross-sectional views showing examples of cylinder head gaskets.

In FIG. 1, there is shown a portion of a cylinder head gasket 10 which comprises at least one opening 12 provided for the passage of a combustion chamber, of dimensions substantially identical to this latter and passage openings 14 adapted to let pass securement screws ensuring the connection of the cylinder head to the engine block (not shown).

In the case of a multi-sheet cylinder head gasket, this latter comprises at least two sheets, one ribbed and the other substantially flat.

Preferably, as shown in FIGS. 3A and 3B, the cylinder head gasket comprises a first sheet 16 with a rib 18, a second sheet 20 with a rib 22 and a third sheet 24, substantially flat, serving as a wedge, disposed between the two first sheets 16 and 20, the two ribs 18 and 22 coming into contact against the third metal sheet 24.

The metal sheets 16 and 22 provided respectively with ribs 18 and 22 permit perfect sealing, in particular at the time of assembly movements of the cylinder head—engine block.

Furthermore, at the edge of each opening corresponding to a combustion chamber, a wedge 26 called a stopper is provided, so as to ensure the function of limiting compression of the ribs 18, 20. This wedge permits high pressure in the combustion chambers, the cylinder head gasket being strongly compressed between the engine block and the cylinder head by securement screws without however the ribs being flattened.

Contrary to the cylinder head gaskets of the prior art, according to the invention, the stopper 26 is not disposed against one of the surfaces of the sheet 24 to which it is connected but edge to edge with said sheet 24.

This arrangement has numerous advantages, particularly as to the production and securement of the stopper 26 on the sheet 24, which will be set forth later.

According to another characteristic of the invention, the thickness of the stopper varies about the circumference as shown in FIG. 2.

This variation of thickness permits compensating variations of pressure all about the combustion chamber, that arise from the securement means of the cylinder head on the engine block, the pressure being much greater in regions near the passage openings 14 than in the regions remote from said openings 14.

According to a preferred embodiment, the stopper has a thickness which varies according to a sinusoidal curve with reduced thickness in the regions located angularly in line with the passage openings 14, at 45°, 135°, 225° and 315° and a greater thickness in the intermediate regions, at 0°, 90°, 180°, 270°.

Preferably, the stopper 26 comprises indexing means 28 so as to position it angularly relative to the rest of the gasket and particularly relative to the passage openings 14.

In the case in which the stoppers of each combustion chamber are independent and each have a ring shape as shown in FIG. 1, each stopper 26 comprises a projecting element 30, called a lug, provided at its periphery, adapted to be received in a hollow shape 32 provided on the edge 34 of the sheet 24.

In the case in which the stoppers of the combustion chambers are connected to each other by webs as shown in FIGS. 4 and 5B, the stoppers 26 themselves fulfill the indexing function.

According to another characteristic of the invention, this stopper 26 comprises a body 36 and, on at least one of the surfaces of the body facing the ribbed sheet 16 or 20, a projecting rib 38. Preferably, this rib 38 has a symmetrical profile about a vertical axis 39 of the cross-section, for example in a semicircle to ensure better sealing.

As the case may be, the variation in thickness of the stopper 26 is obtained, either by causing the thickness of the body 36 to vary, or by causing the height of the rib 38 to vary.

As a modification, the stopper can comprise on each surface, a projecting rib 38 as shown in FIGS. 5B and 6, a projecting rib 38 on one of the surfaces and a hollow rib 40 on the opposite surface as shown in FIGS. 3A, 3B, 5A and 8, or a single projecting rib 38 on one of the surfaces as shown by FIG. 7.

Similarly, there can be envisaged another rib profile such as trapezoidal for example, as shown in FIGS. 7 and 8.

As the case may be, the stopper can comprise an extension 42 which extends over the external periphery of the stopper so as to extend in part between the two ribs 18 and 22 of the external sheets 16, 20 as shown in FIG. 5A, or so as to interconnect two stoppers 26 as shown in FIG. 5B.

The stopper 26 can be secured to the sheet 24 by assembly techniques well known to those skilled in the art such as for example laser welding, spot welding, cementing, clinching.

According to another characteristic of the invention, the connection between the stopper 26 and the sheet 24 is obtained by plastic deformation, particularly by radial expansion of said stopper 26.

In all the figures, there is shown a space between the stopper 26 and the sheet 24 so as to better show that the two elements are separate. It is obvious that in reality, these two elements are disposed one against the other.

According to a preferred embodiment, the profile of the stopper 26 is obtained by plastic deformation, more particularly by stamping, the radial expansion being obtained in the course of this same operation.

Thus before the stamping operation, the stopper is present in the form of a ring of any shape, for example rectangular or square, and of an external diameter equal to or slightly less than the internal diameter of the sheet 24. In the course of the stamping operation, the stopper is compressed between two matrices so as to obtain the desired profile. At the same time, there is also obtained a radial expansion of the stopper which gives rise to an increase of the external diameter so that the stopper is fixed to the sheet 24.

Preferably in the case in which the sheet 24 has a thickness less than that of the stopper, the securement of the stopper to the sheet is obtained not only by radial expansion but also thanks to the formation of two flanges 24 on the stopper, on each side of the sheet 24, thus clamping said sheet, as shown in FIG. 3A.

This securement technique can be applied to all the stopper profiles, at the time the latter is disposed edge to edge with the intermediate sheet 24.

The fact of separating the stopper and the sheet permits reducing to the minimum the stamping loads to obtain the desired profile of the stopper.

In FIGS. 9 to 13, there is shown by way of example different cylinder head gaskets.

In FIG. 9, the gasket comprises a single functional ribbed sheet 46, a single substantially flat sheet 48 serving as a wedge, and a stopper 50.

In FIG. 10, the gasket comprises two ribbed sheets 52, 54 secured against each other, the ribs being disposed in opposition, another ribbed sheet 56, a substantially flat sheet 58 serving as a wedge and a stopper 60, both disposed between the sheets 52 and 54 on the one-hand, and the sheet 56 on the other hand.

In FIG. 11, the gasket comprises the same elements as in FIGS. 3A and 3B, a wedge 62 in the form of a ring being disposed below the stopper 26.

In FIG. 12, the gasket comprises the same elements as in FIGS. 3A and 3B, one of the ribbed sheets, for example 20, being substantially flat.

In FIG. 13, the gasket comprises on opposite sides of a substantially flat sheet 64 and a stopper 26, a pair of ribbed sheets 66, 68, secured against each other, the ribs being disposed in opposition.

No matter what the cylinder head gasket, the stopper is disposed edge to edge with the sheet serving as a wedge. Preferably, this stopper has a variable thickness about its circumference.

Of course, the invention is clearly not limited to the embodiments illustrated and described above, but on the contrary covers all modifications, particularly as to the profile of the stopper, and the materials used.

1. Cylinder head gasket with at least one opening (12) corresponding to a combustion chamber, comprising on the one hand a stack of at least one sheet (16, 20) comprising a rib (18, 22) provided about each opening, and at least one sheet (24) serving as a wedge, and on the other hand, a wedge, called a stopper (26), provided to limit the compression of the rib (18), said stopper (26) and said sheet (24) serving as a wedge being disposed edge to edge and comprising connection means, characterized in that said connection means are obtained by plastic deformation, more precisely by radial expansion of said stopper (26), this latter having, before deformation, an external diameter equal to or slightly less than the internal diameter of the sheet (24) serving as a wedge and being disposed edge to edge relative to said sheet.

2. Cylinder head gasket according to claim 1, characterized in that the connection means comprise two flanges (44) at the stopper (26), on each side of the sheet (24), thereby clamping said sheet.

3. Cylinder head gasket according to claim 1 or 2, characterized in that the stopper (26) has a thickness which varies about its circumference.

4. Cylinder head gasket according to claim 3, characterized in that the stopper (26) has a thickness which varies, with a reduced thickness in zones located angularly in line with passage openings (14) and a greater thickness in the intermediate regions.

5. Cylinder head gasket according to claim 3 or 4, characterized in that the stopper (26) comprises means (28) for indexing so as to position it angularly relative to the rest of the gasket, and particularly relative to the passage openings (14).

6. Cylinder head gasket according to any one of claims 1 to 5, characterized in that the stopper (26) comprises a body (36) and, on at least one of the surfaces of the body facing the ribbed sheet (16, 20), a projecting rib (38).

7. Cylinder head gasket according to claim 6, characterized in that the projecting rib (38) has a symmetrical profile about a vertical axis (39) of the cross-section of the stopper.

8. Cylinder head gasket according to claim 6 or 7, characterized in that the variation of thickness of the stopper is obtained by causing the thickness of the body (36) to vary.

9. Process for the securement of the stopper used in a cylinder head gasket according to any one of claims 1 to 8, characterized in that the connection between the stopper (26) and the sheet (24) is obtained by plastic deformation, more particularly by radial expansion of said stopper (26), this latter having, before deformation, an external diameter equal to or slightly less than the internal diameter of the sheet (24) serving as a wedge and being disposed edge to edge relative to said sheet.

10. Process for securement of the stopper according to claim 9, characterized in that the securement of the stopper on the sheet serving as a wedge is obtained not only by radial expansion but also thanks to the formation of two flanges (44) on the stopper (26), on each side of the sheet (24), thereby clamping said sheet.

11. Process for securement of the stopper according to claim 9 or 10, characterized in that the radial expansion required for the securement of the stopper is produced at the time of production of the desired profile of the stopper, obtained by plastic deformation, particularly by stamping.
